(19) United States
(12) Patent Application Publication
(10) Pub. No.: US 2017/0252679 A1
(43) Pub. Date: Sep. 7, 2017

(54) WATER FILTER

(71) Applicant: SAGAN INDUSTRIES LLC, Cedar City, UT (US)

(72) Inventors: Richard B. Muir, San Diego, CA (US); Dennis M. Clements, Cedar City, UT (US)

(21) Appl. No.: 15/446,712

(22) Filed: Mar. 1, 2017

Related U.S. Application Data
(60) Provisional application No. 62/301,975, filed on Mar. 1, 2016.

(51) Int. Cl. B01D 29/33; C02F 1/44; C02F 1/00

(52) U.S. Cl. CPC B01D 29/333; C02F 1/003; C02F 1/44; C02F 2307/02; B01D 2201/125

(57) ABSTRACT

A filtration system effective to filter bacteria, cysts, and viruses. The small scale filter includes a rigid or semi-rigid core having perforations formed therein, and surrounded by one or more layers of filter media formed into a pleat pack filter arrangement.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. This application claims the benefit of priority to U.S. Provisional Application No. 62/301,975, filed Mar. 1, 2016, the entire contents of which are hereby incorporated by reference.

### BACKGROUND

### Field

The current disclosure relates to water filters and water filtration.

### SUMMARY OF THE INVENTION

In one aspect described herein, a small-scale water filter comprises a perforated core having a center channel running therethrough, an inner filter disposed around the core, the inner filter comprising from 14 to 16 pleats, a netting disposed around the inner filter. In some embodiments, the small-scale water filter also comprises an outer filter disposed around the netting, the outer filter comprising from 14-16 pleats, and wherein the small-scale water filter is effective to filter 99.99% of viruses, 99.9999% of bacteria, and 99.99% of cysts/giardia/cryptosporidium for 250-300 gallons.

In another aspect, a filtration unit comprises a perforated core having a center channel running therethrough; a top end cap connected to a first end of the perforated core; a bottom end cap connected to the second end of the perforated core; and an inner filter disposed at least partially around the perforated core.

In some embodiments, the inner filter is a pleated filter comprising from 26 to 28 pleats, and wherein the average pleat depth of the pleats of the inner filter is about 9.75 mm.

In some embodiments, the filtration unit comprises a netting disposed at least partially around the inner filter, and disposed between the inner filter and the outer filter.

In some embodiments, the inner filter comprises 14 to 16 pleats, and the outer filter comprises 14-16 pleats.

In some embodiments, the filtration unit is effective to filter 99.99% of viruses, 99.9999% of bacteria, and 99.99% of cysts/giardia/cryptosporidium for 250-300 gallons.

In some embodiments, the top cap comprises an outlet port, and wherein the outlet port is in fluid communication with the center channel of the perforated core.

In some embodiments, the inner filter is a pleated filter, and the average pleat depth of the pleats of the inner filter is from about 4 mm to about 7 mm.

In some embodiments, the inner filter is a pleated filter, and the average distance between peaks of the inner filter is about 3.5 mm.

In some embodiments, the outer filter is a pleated filter, and the average pleat depth of the pleats of the outer filter is from about 5 mm to about 7 mm.

In some embodiments, the inner filter is a pleated filter, and the average distance between peaks of the inner filter is from about 7 mm to about 8 mm.

In another aspect, a method of filtering a fluid comprises immersing a filtering unit in a fluid to be filtered, wherein the filtering unit comprises: a perforated core having a center channel running therethrough; a top end cap attached to a first end of the perforated core;

a second end cap attached to the second end of the perforated core; an inner filter disposed at least partially around the perforated core; and an outer filter disposed at least partially around the inner filter; applying a suction to the center channel of the perforated core; drawing the fluid to be filtered through the outer filter, through the inner filter, and into the center channel of the perforated core.

In some embodiments, the top cap filtration unit comprises an outlet port in fluid communication with the center channel of the perforated core.

In some embodiments, the method further comprises attaching a tube to the outlet port; applying suction to the tube, thereby applying a suction to the center channel of the perforated core.

In some embodiments, applying suction comprises applying suction by a user's mouth.

In some embodiments, drawing the fluid through the inner filter filters 99.99% of viruses, 99.9999% of bacteria, and 99.99% of cysts/giardia/cryptosporidium for 300 gallons.

In another aspect, a filtration unit comprises a filter membrane disposed around a central channel; a top end cap connected to a first end of the filter membrane; a bottom end cap connected to a second end of the of the filter membrane; an elongate support member connected to the top end cap at a first end and connected to the bottom end cap at a second end.

In some embodiments, the filtration unit comprises a plurality of elongate support members disposed around a circumference of the filter membrane.

In some embodiments, the filtration unit further comprises an outer filter disposed at least partially around the filter membrane.

In some embodiments, the elongate support member is connected to the top end cap and the bottom end cap having a gap between an inner surface of the elongate support member and a surface of the filter membrane.

In some embodiments, the elongate support member comprises a perforated sleeve surrounding the filter membrane and having a plurality of perforations formed therein.

### BRIEF DESCRIPTION OF THE DRAWINGS

FIG. 1A illustrates an exploded perspective view of an embodiment of a filtration unit having dual filter membranes.

FIG. 1B illustrates an a front view of an embodiment of a housing for a filtration unit of FIG. 1A.

FIG. 2A illustrates a side view of an embodiment of a filtration unit.

FIG. 2B illustrate a side view and a cross-sectional side view taken at line 3A-3A′ of FIG. 2A.

FIG. 3 illustrates an exploded perspective view of an embodiment of a filtration unit having a single filter membrane.

FIG. 4A illustrates a side view of an embodiment of a filtration unit having a single filter membrane.

FIG. 4B illustrate a cross-sectional view of the filtration unit taken at line 4A-4A′ of FIG. 4A.

FIG. 5 illustrates a cutaway view of an embodiment of a filtration unit with two filters.

FIG. 6 illustrates a top view of an embodiment of a double pleat filter pack.

FIG. 7A illustrates a side views of an embodiment of a filtration unit with multiple supports that placed around the filter membrane.

FIG. 7B illustrates a side view of an embodiments of a filtration unit with a support that surrounds the filter membrane.

### DETAILED DESCRIPTION

In the following detailed description, reference is made to the accompanying drawings. In the drawings, similar symbols typically identify similar components, unless context dictates otherwise. Thus, in some embodiments, part numbers may be used for similar components in multiple figures, or part numbers may vary from figure to figure. The illustrative embodiments described herein are not meant to be limiting. Other embodiments may be utilized, and other changes may be made, without departing from the spirit or scope of the subject matter presented. It will be readily understood that the aspects of the present disclosure and illustrated in the figures, can be arranged, substituted, combined, and designed in a wide variety of different configurations by a person of ordinary skill in the art, all of which are made part of this disclosure.

Reference in the specification to “one embodiment,” “an embodiment,” or “in some embodiments” means that a particular feature, structure, or characteristic described in connection with the embodiment is included in at least one embodiment of the invention. Moreover, the appearance of these or similar phrases throughout the specification do not necessarily all refer to the same embodiment, nor are separate or alternative embodiments necessarily mutually exclusive. Various features are described herein which may be exhibited by some embodiments and not by others. Similarly, various requirements are described which may be requirements for some embodiments but may not be requirements for other embodiments.

As used herein, the terms membrane or filter membrane relate to any filter member or media, or to any component which provides a filtering function on a fluid passing therethrough.

Untreated water may contain potentially pathogenic agents, including protozoa, parasites, cysts, bacteria, and viruses. Viruses are often smaller than protozoa, parasites, cysts and bacteria, and thus are more difficult to filter from untreated water. Large filtration units are available that are effective to remove high amounts of cysts, bacteria, and viruses, but these filtration units often large and/or require the use of a hand pump or other mechanical or electrical pumping mechanism to create sufficient pressure to move water over the filter membrane or filter media and through the filter. Generally, filters that efficiently and effectively remove viruses require a high pressure to move water or other fluid through the filter membrane and are difficult to operate without mechanical assistance.

In one aspect, the present disclosure relates to a small filtration unit that is effective to remove cysts, bacteria, and/or viruses but does not require a large force to move fluid through the filter media and which does not require a high differential pressure across the filter and filter membrane or filter media. In some embodiments of a filtration unit described herein, a human user is able to easily draw water through the filtration unit using a tube or straw attached to the filtration unit without using a pump or other mechanical assistance, and using only a suction applied by a user sucking on the tube or straw, effectively filter cysts, protozoa, parasites, bacteria, and viruses. Such small filtration units can be useful in small, portable water bottles and used with a straw or tube or other drinking mechanism. The user can draw water out of the water bottle by sucking on a straw connected to the filtration unit, creating suction, so the water passes through the filtration device and out through the straw to the user. The filtration unit may also be placed directly in the untreated water (e.g. lake or stream), and the user can suck water through the filter. The user may suck through a tube connected to the filtration unit, creating suction, so the water passes through into the filtration unit, across one or more filter membranes and out through the tube. The fluid to be filtered will flow through the filtration unit with merely human suction and does not require a hand pump or other pumping mechanism, and is still effective to filter viruses, bacteria, cysts, and other biological contaminants to a safe level for human consumption.

In some embodiments, the filters described herein can be advantageously used as microfilters, in-line filters, personal filters for water bottles, bladders, in-line filters for hydration bags, and the like. The filters of the current description can also advantageously be small-scale filters, suitable for use in personal applications. In some embodiments, the filtration units can advantageously be from about 2 inches to about 4 inches long. In some embodiments, the filtration units

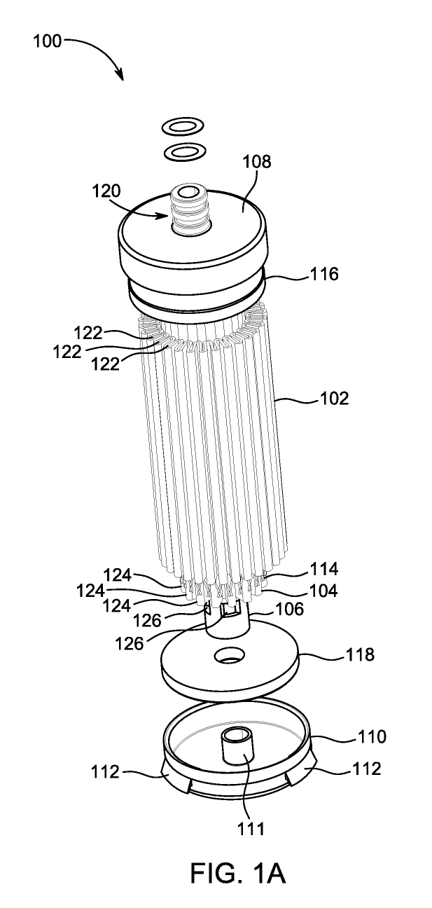

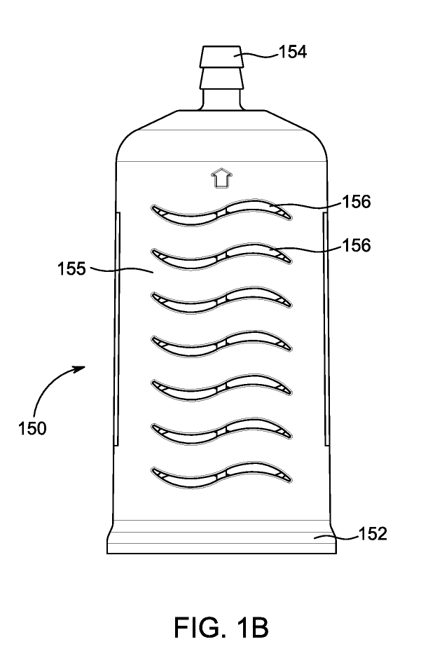

FIG. 1A depicts an exploded view of a filtration unit having two filter layers or filter membranes. The filtration unit 100 has an outer filter 102, an inner filter 104, a core 106, a top end cap 108 and a bottom end cap 110. In general, the core 106 is connected to the core top end cap 108 and the bottom end cap 110 at opposing ends of the core 106. The inner filter 104 at least partially surrounds the core 106, and the outer filter 102 at least partially surrounds the inner filter 104. The inner filter 104 and the outer filter 102 are disposed between the top end cap 108 and the bottom end cap 110.

The top end cap 108 includes an outlet fitting 120 that is adapted to connect to a tube, straw, or other similar conduit or device. In some embodiments, the top end cap 108 may not have a protrusion 120, but instead have an integrally formed outlet device, such as a straw, tube, or the like. The bottom end cap 110 includes flanges 112. In some embodiments, the bottom end cap 110 may have two to four flanges 112. In some embodiments, the bottom end cap 110 may have 3 flanges 112. The flanges 112 extend away from the central axis of the filtration unit 100 and are configured to center the filtration unit 100 within a housing 150 (shown in FIG. 1B).

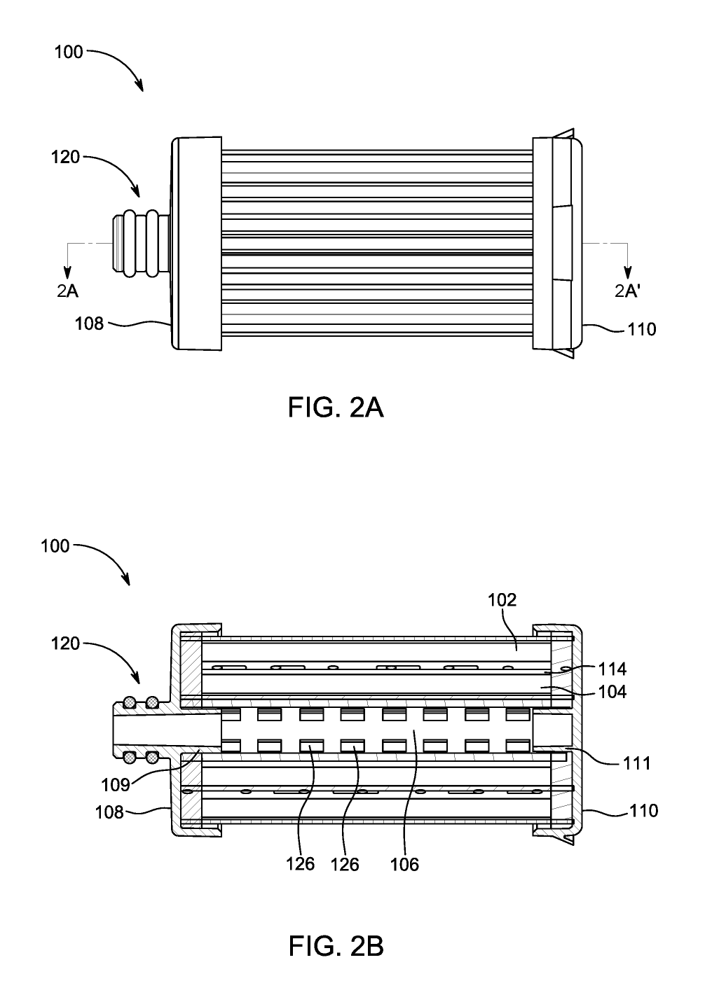

The top and bottom end caps 108 and 110 connect to the core 106. In some embodiments, the core 106 is a central perforated structure. The central core 106 attaches at or near a center point of the top and bottom end caps 108 and 110, and the filter membranes, e.g., the inner and outer filters 104, 102, surround the core 106. In some embodiments, the core 106 is cylindrical and rigid and has a channel formed through the center thereof extending in a direction along the long axis of the core 106. The core 106 has perforations or holes 126 formed therein, extending generally perpendicular to the long axis, connecting the central channel of the core 106 with the external environment of the core 106. The holes 126 allow a fluid, such as water, to flow into the inner channel (not shown) of the core 106. In some embodiments, there may be a row of holes 126, such as four holes 126 evenly distributed around the circumference of the core 106. In some embodiments, as shown in FIG. 2B, there may be 8-10 rows of holes 126 extending along the length of the core 106. In some embodiments, the outer diameter of the core may be about 10.32 mm or about 0.4085 inches. The inner diameter of the core may be about 8.73 mm or about 0.344 inches. The core may be formed of plastic, carbon, ceramic, metal, or a combination of suitable materials known in the art. The core 106 can be advantageously used in small filter applications. The provision of the core 106 in a small filter application is a novel feature in the filtering arts.

The inner filter 104 is disposed around the core 106. The inner filter 104 is connected to or in contact with the top end cap 108 and the bottom end cap 110 in such a way as to preclude fluid flow between a surface of the inner filter 104 and either the top end cap 108 or the bottom end cap 110. This ensures that the fluid to be filtered must pass through the inner filter 104 before the fluid moves into the core 106. This process will be described in greater detail below.

The inner filter 104 includes a plurality of pleats 124. The pleats can be folds or accordion-style structures in the filter membrane. Using pleats such as pleats 124 can increase the surface area of the inner filter 104 which can be contacted by a fluid to be filtered as opposed to a non-pleated filter membrane in a similar diameter filtration unit. In some embodiments, the inner filter 104 comprises 12-16 pleats 124. In some embodiments, the inner filter 104 has from 13 to 15 pleats. The pleat depth can be from about 4 mm to about 7 mm. The average distance between peaks of the pleats in the inner filter 104 is about 3.5 mm.

Once positioned around the core 106, the inner filter may have an inner diameter (that is, the diameter from a centerline of the core 106 and filtration unit 100 to an innermost point of one or more of the pleats 124 of the inner filter 104) of about 12 mm and an outer diameter (that is, the diameter from a centerline of the core 106 and filtration unit 100 to an outermost point of one or more of the pleats 124 of the inner filter 104) of about 25 mm. In some embodiments, the inner filter 104 comprises 15 pleats 124, and is made from Ahlstrom 5283 media, as manufactured by Ahlstrom Corporation, its subsidiaries, or partners. In some embodiments, the inner filter 104 may be made from a medium with the same or substantially similar properties to the Ahlstrom 5283 media. In some embodiments, the inner filter 104 can comprise Ahlstrom 5289 media, although, filter efficiency was reduced where the inner filter was made from Ahlstrom 5289 media as compared to Ahlstrom 5283 media. Ahlstrom media is described in greater detail below.

A netting 114 is disposed around the inner filter 104. The netting 114 can be a porous material, such as a mesh, and is configured to hold the inner filter 104 onto the core, to assist the inner filter 104 to maintain its shape, to provide structural stability to the inner filter 104, and can provide some coarse filtering functionality. The netting 114 may be made from plastic, ceramic, metal, or a combination of suitable materials known in the art. The netting can be formed in a lattice, honeycomb, chain-link, or other similar way such that it can flex and contract in response to a force.

The filtration unit 100 also comprises an outer filter 102, which is disposed around the netting 114 and the inner filter 104. The outer filter is connected to or in contact with the top end cap 108 and the bottom end cap 110 in a way to preclude flow of a fluid to be filtered from passing between the outer filter 102 and either the top end cap 108 or the bottom end cap 110. The outer filter 102 comprises pleats 122. In some embodiments, the outer filter 102 has from 13 to 20 pleats 122. In some embodiments, the outer filter 102 has from 13 to 16 pleats. The pleat depth is from about 5 mm to 7 mm. The average distance between peaks (as measured in a radial direction around the circumference of the pleats 122) of the pleats 122 in the outer filter 102 is from about 7 mm to about 8 mm.

Once positioned around the inner filter 104 and the netting 114, the outer filter may have an inner diameter of about 26 to about 28 mm and have an outer diameter of about 36 mm to about 38 mm. In some embodiments, there may be a netting (not shown) placed around the outer filter 102. The netting around the outer filter 102 may be the same or substantially similar to the netting 114 around the inner filter 104. In some embodiments, the outer filter 102 may have 15 pleats and be a media having powdered activated carbon and silver antimicrobial embedded within an aluminum fiber matrix, such as Ahlstrom 5289 media, as provided by Ahlstrom Corporation, its subsidiaries, or its partners. In some embodiments, the outer filter 102 may be made from a medium with the same or substantially similar properties to the Ahlstrom 5289 media

The outer and inner filters 102 and 104 are connected to the end caps 108 and 110 by adhesives 116 and 118, respectively, which preclude flow of fluid to be filtered between the outer and inner filters 102 and 104 and the top and bottom end caps 108 and 110. The adhesive mechanisms 116 and 118 may be the same or substantially similar to each other. In some embodiments, the adhesives 116 and 118 may be hot melt. In some embodiments, the outer and inner filters 102 and 104 are fit between the top end cap 108 and the bottom end cap 112.

Referring to FIG. 1B, the filtration unit 100 can be contained within a housing 150. The housing 150 comprises a base 152 and a housing outlet 154. The base 152 is configured to receive the filtration unit 100 and contact the bottom end cap 110 and the flanges 112 to keep the filtration unit 100 centered within the housing 150. The flanges 112 contact an inner surface of the base 152 to align the filtration unit within the housing 150. The number of flanges 112 can advantageously be reduced to minimize resistance to flow through the housing and to the filtration unit 100. Aligning the filtration unit 100 within the housing 150 ensures that the outlet fitting 120 will align with the housing outlet 152 such that the outlet fitting 120 can slide into the housing outlet 154. This alignment also and ensures that there is adequate space between the housing and the outer filter 102 for water, or any other fluid to be filtered, to flow around the outer filter 102, and for the water (or other fluid) to contact the maximum surface area of the outer filter 102.

The housing 150 also comprises a shell 155 and a plurality of perforations or voids 156 formed therein. The shell 155 is sized to at least partially enclose the filtration unit 100 and to provide space between the inner surface of the shell 155 and the outer filter 102. The shell also serves to protect the filtration unit from damage from mechanical shock. The perforations 156 in the shell 155 provide a flowpath for a fluid to be filtered to move through the housing 150 and contact the outer filter 102. In some embodiments, the base 152 can also be formed having perforations or voids formed therein.

In some embodiments, the shell 155 may not have perforations or voids formed therein. In this embodiment, the base 152 can include perforations or voids formed therein and the fluid flowpath through the housing would be exclusively through the perforations in the base 152, and then into the shell 155 and around the outer filter 102, and then through the filtration unit as described elsewhere herein. In some embodiments where the shell 155 does not have perforations, the housing 150 can be configured for use as an in-line filter. In these embodiments, the base 152 would comprise an housing inlet fitting or port to which a conduit or tubing could be attached. The housing inlet fitting or port would provide a flow channel through the base 152 and into the interior volume of the shell 155, where the fluid would then through the filtration unit 100 as described elsewhere herein.

FIG. 2A illustrates a side view of an embodiment of a filtration unit 100, and FIG. 2B illustrate a side view and a cross-sectional side view of the filtration unit 100 taken at line 3A-3A′ of FIG. 2A. As shown in FIG. 2B, the core 106 can have a plurality of openings 126 which can be formed in a line along the length of the core 106. In some embodiments, the plurality of openings 126 can be distributed on the core 106 in any desired pattern, or randomly. Also, as can be seen, the core 106 has a hollow, central, cylindrical chamber through which fluid can flow. The core 106 can be received on the bottom end cap 110 via a bottom protrusion 111, which can be inserted or positioned within a bottom portion of the channel of the core 106. The top end cap 108 also comprises a top protrusion 109 which extends into the core 106, and which also has a central void therein. In this way, fluid which has passed through the outer and inner filters 102, 104, and which has moved into the hollow center of the core 106 via the plurality of openings 126 can flow through the void in the top protrusion 111, through the top end cap 108, and out the outlet fitting 120.

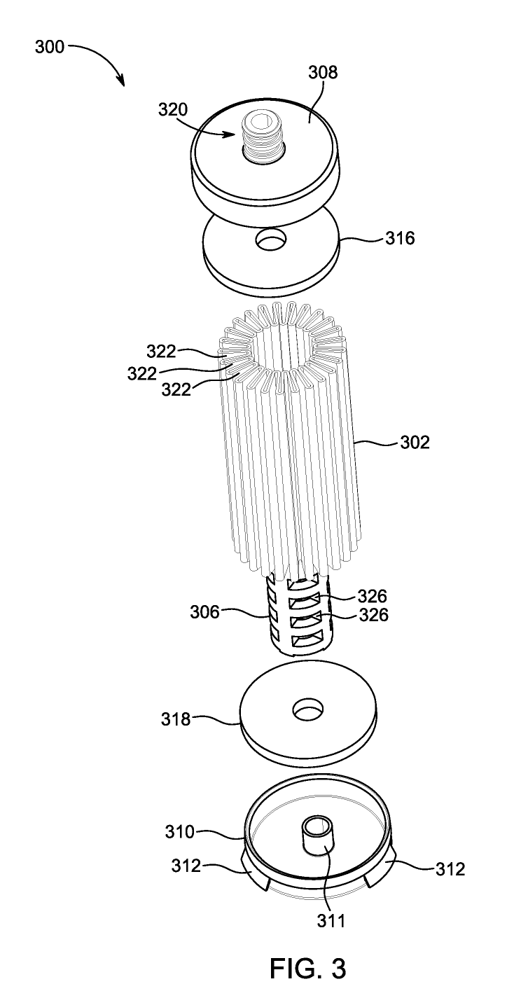

FIG. 3 depicts an embodiment of a filtration unit which has a single filter membrane. In some embodiments, as shown in FIG. 3, the filtration unit 300 has one filter. The filtration unit 300 has two end caps 308 and 310. The top end cap 308 may have an outlet fitting 320 that connects to a tube, straw, or other drinking mechanism (not shown). In some embodiments, the top end cap may not have an outlet fitting 120, but may be integrally formed with another output conduit, such as a straw, valve, or the like. The bottom end cap 310 may have flanges 312. In some embodiments, the bottom end cap 310 may have two to four flanges 312. In some embodiments, the bottom end cap 310 may have 3 flanges 312.

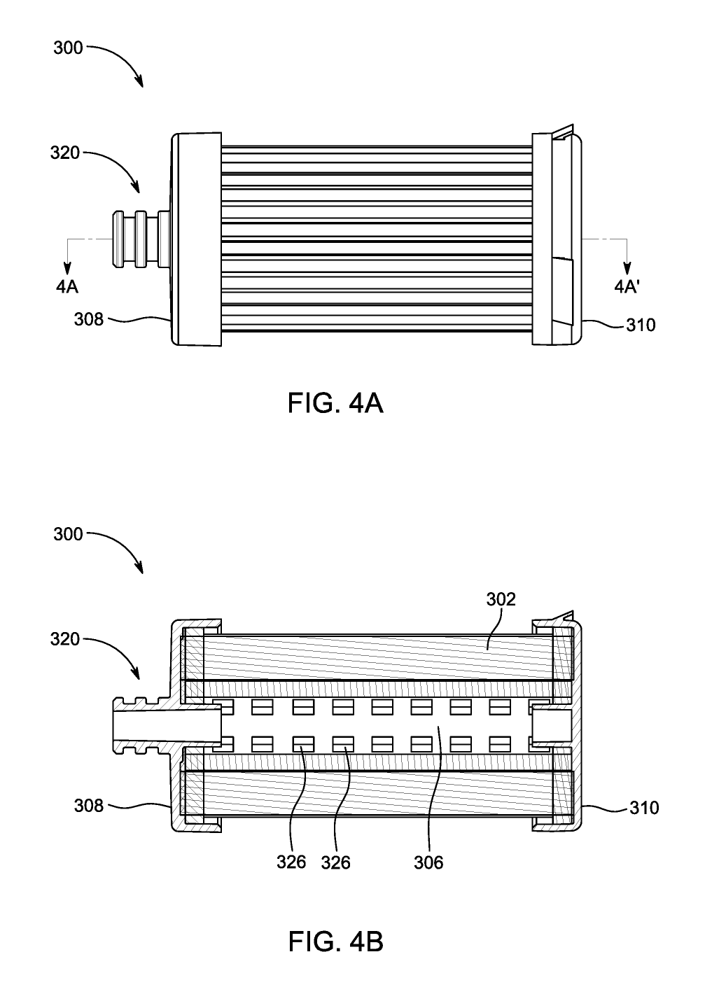

The end caps 308 and 310 connect to a central core 306. The core 306 is cylindrical and rigid. The core 306 has holes 326 along its length, allowing water to flow into the inner channel of the core 306. There may be a row of holes 326, where there are four holes 326 evenly distributed around the circumference of the core 306. In some embodiments, as shown in FIGS. 4A and 4B, the filtration unit may be similar to those described elsewhere herein.

The filter membrane 302 is wrapped around the core 306. The filter membrane 302 has pleats 322. The filter membrane 302 may have 26-28 pleats 322. In some embodiments, the pleat depth can be about 9.75±0.25 mm. Once positioned around the core 306, the filter membrane 302 may have an inner diameter of about 17.5 mm and an outer diameter of about 37 mm. In some embodiments, there may be a netting (not shown) placed around the filter membrane 302. The netting may help the filter membrane 302 maintain its shape and may help with filtering. In some embodiments, the filtration unit, from top end cap 308 to bottom end cap 310 can be about 3 inches long, about 79.5±1 mm. In some embodiments, the filter membrane 302 can be about 76.2±0.5 mm in length.

The filter membrane 302 may be connected to the end caps 308 and 310 by adhesives 316 and 318, respectively. The adhesive mechanisms 316 and 318 may be the same as each or substantially similar. In some embodiments, the adhesives 316 and 318 may be hot melt or other desired adhesives, as described elsewhere herein.

FIG. 4A illustrates a side view of an embodiment of a filtration unit 300, and FIG. 4B illustrate a side view and a cross-sectional side view of the filtration unit 100 taken at line 4A-4A′ of FIG. 2A. The construction and components of the filtration unit can be similar to those described elsewhere herein.

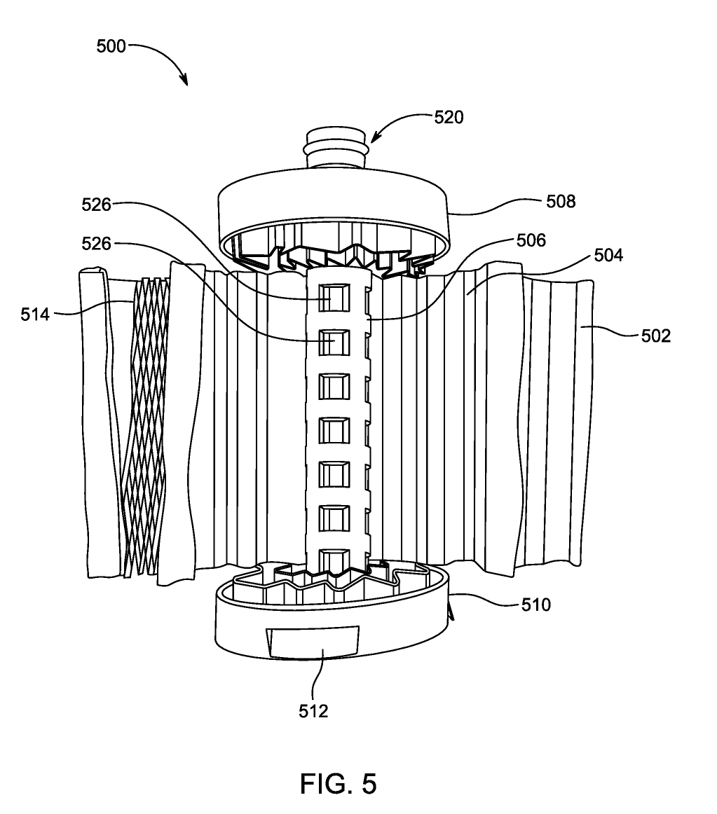

FIG. 5 illustrates a cutaway view of an embodiment of a filtration unit 500. The netting 514, inner filter 504, and outer filters 502 have been cut and opened up to show the central core 506. The core 506 is connected to the end caps 508 and 510. The top end cap 508 has an outlet fitting 520. The bottom end cap 510 has flanges 512. The core 506 has holes 526 along its length. The water flows through the two filters and through the holes 526 in the core 506. The water travels through the core 506 and exits out the outlet fitting 520. A straw, tube, or other drinking mechanism (not shown) may be connected to the outlet fitting 520.

In operation, the filtration unit 500 is placed in a volume of fluid to be filtered. This can be a water bottle, a lake, river, stream, or any other desired container. A user attaches a straw, tubing, or other similar device to the outlet port 120. The user then places the straw or tubing in the user's mouth and draws on the straw or tubing. This creates a vacuum within the straw, tubing, and thereby in the central hollow chamber of the core 506. The lower pressure in the core 506 causes a differential pressure across the inner and outer filter 504, 502. The differential pressure causes fluid from the volume of fluid to move through the outer filter 502, through the netting 514, through the inner filter 504, through the openings 526 in the core 506, into the central hollow chamber of the core 506, out through the outlet port 520, and into the user's mouth. As the fluid passes through the inner and outer filters 504, 502, bacteria, viruses, cysts, protozoa, and parasites are filtered out of the fluid to a desired level.

In tests performed on filtration units which lack a central core 506, when the user draws on the tubing or straw, the filters or pleat packs collapse or are deformed by the vacuum drawn within the filter. The collapse can occur radially, as the filter is drawn in toward a centerline of the filter, or axially, as the end caps are drawn closer to each other. In either case, the collapse and deformation of the filter can increase the required differential pressure across the filter, such that the suction provided by the user is insufficient to sustain flow of filtered water. In some embodiments, test performed on filters with a central core 506, but with different arrangements of pleats 522, 524 had similar undesirable results.

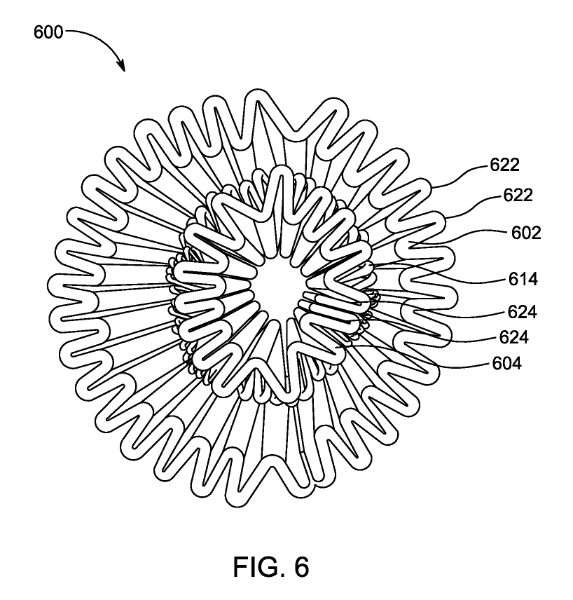

FIG. 6 illustrates an end view of an embodiment of a filter pack 600 without a core. The filter pack 600 comprises an inner filter 604, netting 614, and outer filter 602. The inner filter 604 has 15 pleats 624. The average pleat depth is about 5.3 mm. The average distance between peak to peak of the pleats is about 6.3 mm. The inner and outer diameter of the inner filter are similar to those described elsewhere herein.

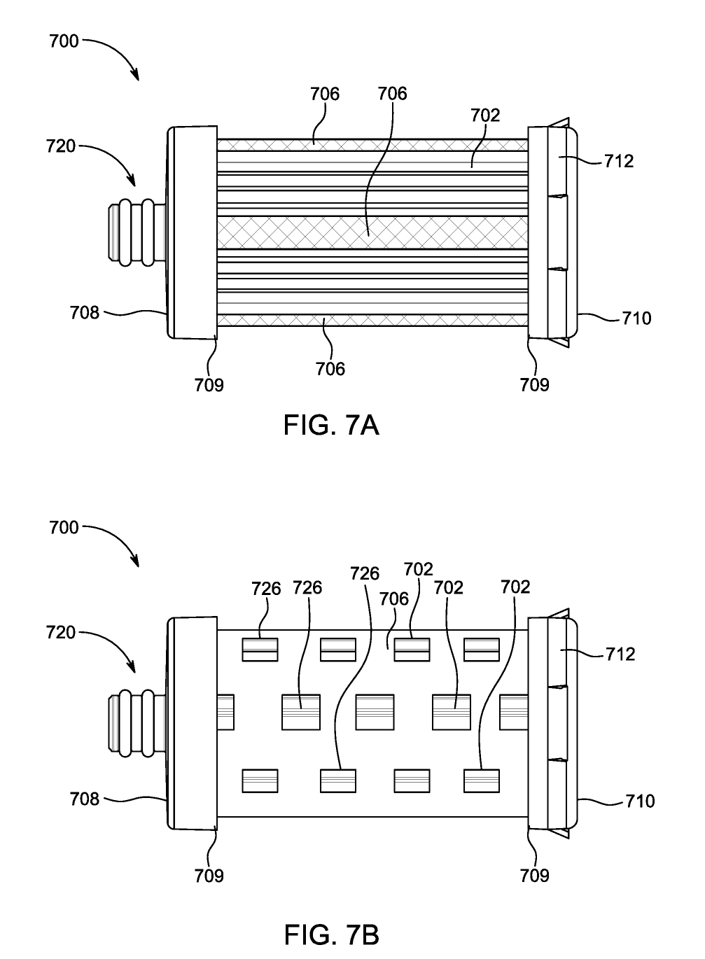

FIGS. 7A and 7B illustrate side views of embodiments of filtration units 700 with a support or supports 706. The filtration unit 700 has two end caps, a top cap 708 and a bottom cap 710. The top end cap 708 has an outlet fitting 720 that is able to connect to a tube, straw, or other similar conduit or device. In some embodiments, the top end cap 708 may have an integrally formed outlet device. The bottom end cap 710 has flanges 712. In some embodiments, the bottom end cap 710 may have two to four flanges 712.

The top and bottom end caps 708, 710 connect to a support 706. The support 706 is rigid and limits the movement of the end caps 708, 710 relative to each other. The support 706 may be formed of plastic, carbon, ceramic, metal, or a combination of suitable materials known in the art. The support 706 helps to maintain the distance between the end caps 708, 710. The support 706 prevents the end caps 708, 710 from pressing on the filter 702 along the long axis and reducing the flow through the filter 702 below a desired level. In some embodiments, there may be some movement of the end caps 708, 710 closer together along the long axis, but not enough movement that flow through the filtration unit 700 is below a desired level. In some embodiments, there is no movement of the end caps 708, 710 closer together along the long axis.

The filtration unit 700 has one pleated filter 702. In some embodiments, the filtration unit 700 may have two pleated filters. In some embodiments, the filter or filters may be similar to those described elsewhere herein. In some embodiments, there may be an inner volume defined by the inner cross-section of the pleated filter 702 and the distance between the end caps 708 and 710. When water is flowing through the filtration unit 700, the pleated filter 702 may compress, such that the inner cross-sectional area of the pleated filter decreases when compared to the inner cross-sectional area of the pleated filter 702 when water is not flowing through the filtration unit. In some embodiments, when the water filtration unit 700 is in use, the inner cross-sectional area of the pleated filter 702 is smaller than the inner cross-sectional area of the pleated filter 702 when the water filtration unit 700 is not in use. In some embodiments, the inner cross-sectional area of the pleated filter 702 during use is the same or substantially similar to the inner cross-sectional area of the pleated filter 702 when not in use.

In another aspect the present disclosure relates to a small filtration unit that allows some deflection of the filter in the radial direction but limits the deflection of the filter along axially, or along its long axis. The dimensions and design of the pleated filter is such that the filter can partially compress in the axial direction and still have a flow through the filtration unit that meets a desired flow level and/or effective filtration of bacteria, viruses, and cysts/giardia/cryptosporidium as described elsewhere herein. In some embodiments, the desired flow level is such that water is able to flow through the filtration unit with human suction and does not require a hand pump or other pumping mechanism.

In some embodiments, there may be one or more support 706. As illustrated in FIG. 7A, there may be four supports 706 distributed around the outer or inner circumference of the end caps 708, 710, three supports are visible and the fourth is not visible. The size and number of supports 706 is such that the movement of the end caps 708, 710 along the long axis is limited and does not restrict the flow through the filtration unit 700. The support or supports 706 prevent the distance between the end caps 708 and 710 from being an ineffective distance. At an ineffective distance, the flow of fluid through the filtration unit 700 is below a desired flow level and/or the filtration of viruses, bacteria, and/or cysts/giardia/cryptosporidium is below a desired level as described elsewhere herein. In some embodiments, there may be a central perforated core 106, as described in reference to FIGS. 2A and 2B. In some embodiments, there is no central core. In some embodiments, the multiple supports 706 may have perforations or holes 726 formed therein as illustrated in the support 706 of FIG. 7B.

As illustrated in FIG. 7B, the support 706 may extend around the outer circumference of the filter 702 as a perforated sleeve. In some embodiments, the support 706 may extend partially around the outer circumference of the filter. The support 706 may have perforations or holes 726 formed therein. The holes 726 allow a fluid, such as water, to flow through the support 706 to the filter 702. In some embodiments, there may be 8-10 rows of holes 726 extending along the length of the support 706. In some embodiments, there may be more or less rows of holes 726.

In some embodiments, the support or supports 706 may be connected to the end caps 708 and 710 by adhesives. The adhesives may be hot melt or other desired adhesives. In some embodiments, the support or supports 706 may connect to the end caps 708 and 710 via snap fit, custom fit, clip, screw, other suitable connecting mechanisms, or a combination of suitable connecting mechanisms. In some embodiments, one or more of the supports 706 may be integral with one or both end caps 708 and 710.

In some embodiments, one or more of the supports 706 may be positioned inside the rims 709 of the end cap 708, 710. In some embodiments, one or more of the supports 706 may be positioned such that the support or supports 706 are generally aligned with the rims 709 of the end caps 708, 710. In some embodiments, one or more of the supports 706 may be positioned outside of the rims 709 of the end cap 708, 710. In some embodiments, one or more of the supports 706 may be positioned such that the outer diameter of the support or supports 706 is positioned inside of the outer diameter of the end caps 708, 710. In some embodiments, one or more of the supports 706 may be positioned such that the outer edge of the support or supports 706 is generally aligned with the outer diameter of the end caps 708, 710. In some embodiments, one or more of the supports 706 may be positioned such that the outer edge of the support or supports 706 is positioned outside of the outer diameter of the end caps 708, 710.

Referring again to FIG. 1A, the number of pleats in the inner filter 104 and the outer filter 104 affect the efficiency or removal rate of the filtration unit. The diameter of the inner and outer filters 104 and 102, and their associated pleats 124, 122, and the number of pleats 124, 122 can affect the flow rate through the filter. As the diameter of the filtration unit 100, and, thus, the diameter from the centerline of the core 106 to any portion of the inner and outer filters 104, 102 is smaller, keeping the same number of pleats 124, 122 will cause the pleats 124, 122 to be bunched closer together, or surfaces to contact adjacent surfaces, which can limit the available surface area for a fluid to pass through, and can increase the required differential pressure across the filter media. Thus, controlling the number of pleats is important to improving the flow rate across the filter media and the required pressure to initiate flow.

The number of pleats 122, 124, the height of the pleats 122, 124, the distance between adjacent peaks in pleats 122, 124, the number of filter membranes, also affect filtering efficiency. The same is true for the filtration units described with regard to FIG. 3. Conventionally, it was understood that efficient virus filtration needed a surface area that was larger than could be accommodated in the small filtration units that are the described in the present disclosure. The inventors found that existing small-scale filters did not provide filtering efficiency for viruses and were difficult to suck water through using a user's mouth. Simply making a large filter smaller did not provide the filtering efficiency required, and often required an increased differential pressure across the filter membrane to draw water through. In early experiments the inventors surprisingly discovered that the number of pleats in a filter pack can affect the efficiency of filtering viruses. Surprisingly, reducing the pleat count from those of larger filters improved the virus filtration efficiency and lowered the differential pressure required across the filter media. Filter configurations having different pleat dimensions and counts, with and without cores, and with various filter media were performed and these filter configurations failed to provide acceptable filtration results, especially for viruses. The inventors found that existing small-scale filters did not provide filtering efficacy for viruses, were difficult to suck water through using a user's mouth.

Increasing the number of pleats in a filtering media can increase the effective surface area; however, if the pleats are too tightly packed then the surface area may be diminished as the pleats push against each other. In order to meet the EPA testing standards for removal of microbial organisms, the number of filters used, type of filter media used, number of pleats in the filters, depth of pleats as well as other parameters may need to be adjusted. Other parameters may include but are not limited to the number of flanges in the end caps, the outer diameter of the filter outlet, etc. In some embodiments, when a single filter is used there may be 26-28 pleats. In some embodiments, when two filters are used there may be 14-16 pleats in the inner filter and 14-16 pleats in the outer filter. Additionally, in a small filtration unit 100 without a core, when a suction is applied to the filtration unit, the pleats 122, 124 can undesirably collapse and deform, which reduces the effectiveness of the inner and outer filters 102, 104 and increases the required differential pressure to generate flow of filtered fluid.

The number of flanges in the end caps may affect the flow rate through the filtration unit and the efficiency of the unit. The number of flanges in the end caps may affect the flow of water going into the outer filter 102. Reducing the number of flanges may make the flow of water less turbulent, and thus, increasing flow rate and efficiency. The outer diameter of the filter outlet port 120 may affect the flow rate through the filtration unit and the efficiency of the unit. Increasing the outer diameter of the filter outlet may improve the flow of water through the filtration unit.

In use, the filtration units of the present application can be submerged in a fluid to be filtered. As a suction is applied, such as a person sucking through the straw, the fluid flows over and through the outer filter layer 102, through the netting 114, over and through the inner filter layer 104, through one or more of the openings 126 in the core 106, through the center channel of the core 106, and out the outlet fitting 120. In some embodiments, the outer diameter of the outlet fitting can be from about 2 mm to about 6 mm.

In some embodiments, Ahlstrom filter media may be used. The filter medium may be made from alumina nanofibers, which are very small fibers made from aluminum metal or aluminum containing materials. The fibers may range in size from 1-100 nm in diameter and up to several micrometers in length. Alumina nanofibers consist of either aluminum oxide (Al2O3) or aluminum hydroxide (AlOOH), commonly referred to as boehmite, or aluminum trihydroxide [Al(OH)3], commonly referred to as gibbsite, bayerite, or nordstrandite. Boehmite fibers may be about 2 nm in diameter and 200-300 nm in length. The alumina nanofibers may be incorporated onto submicron glass fibers which are then bonded onto a pleated filter medium. The resulting filter medium has pore sizes of about 2-3 micrometers. However, due to the electrostatic attraction much smaller particles (e.g. viruses) could potentially be removed through adsorption, effectively making the filter function as though it had much smaller, submicron pore sizes similar to a membrane filtration technology such as ultrafiltration. With an actual pore size of about 2-3 micrometers, the filter could allow a high rate of flow with a low pressure drop compared to membrane technologies.

The Ahlstrom 5283 filter medium may have a 1.25 micron mean pore size and remove pathogens and colloids. The Ahlstrom 5289 filter medium may contain powdered activated carbon with silver impregnated zeolite in addition to the nanoalumina coated glass microfibers. The Ahlstrom 5289 filter medium may have a 1.25 micron mean pore size and remove pathogens, colloids, chlorine taste and odor, some chemicals (e.g. humic acid).

Ahlstrom filters remove submicron contaminants through electroadhesion and ion exchange as opposed to traditional mechanical filter media. The crystal structure of the mineral creates a natural electrokinetic potential of Al+++ on the surface of the fiber. The charge is not an electrostatic charge that can be dissipated by alcohol immersion, but instead is a charge potential that maintains integrity between 5-9.5 pH in polar liquids. The available hydroxyl group in each fiber will also exchange protons with many electropositive colloids to retain them through a form of ion exchange. The small size of the alumina nanofibers allows for electro adsorption of submicron particles. The crystal structure of pseudoboehmite allows for an extremely high surface area and a large number of active sites for submicron containment removal.

The filter media can be designed with both mechanical and adsorptive filtering properties. The pore size of the media is such that the charge field covers the entire void volume of every pore. There may be about 400 layers of these pores in the thickness of the media that contamination pass through during filtration, creating a tortuous path. The charge field removes the negatively charged submicron particles while larger particles are captured within the fiber structure of the media. Generally, the mean pore size is 1.25 microns and the cartridge pressure drop is less than 0.1 bar. The larger physical pore size allows for higher flow rates and lower pressure drop, and can still remove submicron particles due to the inherent charge field extending across the void volume of the pores.

Tests were performed on filtration units having a single filter membrane comprising a filter membrane made from Ahlstrom 5289 with 18 to 25 pleats and a central core, such as those described with regard to FIG. 3. The filtration unit with the single filter membrane performed well in tests that were conducted and passed the EPA Guide Standard for removal of microbial organisms. In filtration tests, the single filter membrane filtration unit achieved removal rates of 99.9999% for bacteria, up to 99.99% for viruses, and 99.9% for Cysts/Giardia/Cryptosporidium for up to 250 gallons passed through the filtration unit. The bacteria used in filtration tests were roultella terrigena bacteria, which is commonly used as a model to evaluate a filter's bacterial removal efficacy. The virus tests were performed using MS-2 bacteriophage, which has a shape and size similar to human enteroviruses and is commonly used to evaluate a filter's viral removal efficacy. Fluorescent microspheres were used as surrogates for cryptosporidium oocysts.

Tests were also performed on filtration units having an inner filter and an outer filter, such as those described with regard to FIG. 1. In some embodiments, the filtration unit 100 advantageously comprises an inner filter 104 comprising 15±2 pleats 124, and the outer filter 102 comprises 15±2 pleats 122. In one embodiment, the filtration unit has a double pleat filter pack comprising of an inner filter made from Ahlstrom 5283 media with 15 pleats, an outer filter made from Ahlstrom 5289 with 14-16 pleats, and a central core. The filtration units performed on filters having an inner and an outer filter, such as those depicted in FIG. 1, performed well in tests that were conducted and passed the EPA Guide Standard for removal of microbial organisms. The double filter filtration unit 100 achieved removal rates of a 99.9999% removal rates of bacteria, 99.997% of viruses, and 99.997% of Cysts/Giardia/Cryptosporidium for up to 300 gallons through the filtration unit. The bacteria used in filtration tests were roultella terrigena bacteria, which is commonly used as a model to evaluate a filter's bacterial removal efficacy. The virus tests were performed using MS-2 bacteriophage, which has a shape and size similar to human enteroviruses and is commonly used to evaluate a filter's viral removal efficacy. Fluorescent microspheres were used as surrogates for cryptosporidium oocysts.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others. The scope of the invention is indicated by the appended claims rather than by the foregoing description. All changes which come within the meaning and range of equivalency of the claims are to be embraced within their scope.

The foregoing description details certain embodiments of the systems, devices, and methods disclosed herein. It will be appreciated, however, that no matter how detailed the foregoing appears in text, the systems, devices, and methods may be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those skilled in the art that parts included in one embodiment are interchangeable with other embodiments; one or more parts from a depicted embodiment may be included with other depicted embodiments in any combination. For example, any of the various components described herein and/or depicted in the figures may be combined, interchanged or excluded from other embodiments.

The processes or steps of any flow charts described and/or shown herein are illustrative only. A person of skill in the art will understand that the steps, decisions, and processes embodied in the flowcharts described herein may be performed in an order other than that described herein. Thus, the particular flowcharts and descriptions are not intended to limit the associated processes to being performed in the specific order described.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All references cited herein are incorporated herein by reference in their entirety. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

All numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims.

What is claimed is:

1. A small-scale filtration unit comprising:
a perforated core having a center channel running therethrough;
a top end cap connected to a first end of the perforated core;
a bottom end cap connected to the second end of the perforated core; and
an inner filter disposed at least partially around the perforated core, wherein the center channel of the perforated core is in fluid communication with the inner filter.

2. The filtration unit of claim 1, wherein the inner filter is a pleated filter comprising from 26 to 28 pleats, and wherein the average pleat depth of the pleats of the inner filter is about 9.75 mm.

3. The filtration of claim 1, wherein the filtration unit is effective to filter 99.99% of viruses, 99.9999% of bacteria, and 99.99% of cysts/giardia/cryptosporidium for 300 gallons.

4. The filtration unit of claim 1, wherein the top cap comprises an outlet port, and wherein the outlet port is in fluid communication with the center channel of the perforated core.

5. The filtration unit of claim 1, wherein the inner filter comprises 14 to 16 pleats.

6. The filtration unit of claim 5, wherein the inner filter is a pleated filter, and the average pleat depth of the pleats of the inner filter is from about 4 mm to about 7 mm.

7. The filtration unit of claim 5, wherein the inner filter is a pleated filter, and the average distance between peaks of the inner filter is about 3.5 mm.

8. The filtration unit of claim 1 further comprising an outer filter disposed at least partially around the inner filter.

9. The filtration unit of claim 10, wherein the outer filter is a pleated filter comprising from 14 to 16 pleats, and having an average pleat depth of from about 5 mm to about 7 mm.

10. The filtration unit of claim 10, wherein the average distance between peaks of the outer filter is from about 7 mm to about 8 mm.

11. A method of filtering a fluid comprising:
immersing a filtering unit in a fluid to be filtered, wherein the filtering unit comprises:
a perforated core having a center channel running therethrough;
a top end cap attached to a first end of the perforated core;
a second end cap attached to the second end of the perforated core;
an inner filter disposed at least partially around the perforated core;
applying a suction to the center channel of the perforated core;
drawing the fluid to be filtered through the inner filter, through one or more perforations in the perforated core, and into the center channel of the perforated core.

12. The method of claim 11, wherein the top cap filtration unit comprises an outlet port in fluid communication with the center channel of the perforated core.

13. The method of claim 12 further comprising:
attaching a tube to the outlet port;
applying suction to the tube, thereby applying a suction to the center channel of the perforated core.

14. The method of claim 13, wherein applying suction comprises applying suction by a user's mouth.

15. The method of claim 11, wherein drawing the fluid through the inner filter filters 99.99% of viruses, 99.9999% of bacteria, and 99.99% of cysts/giardia/cryptosporidium for 300 gallons

16. A filtration unit comprising:
a filter membrane disposed around a central channel;
a top end cap connected to a first end of the filter membrane;
a bottom end cap connected to a second end of the of the filter membrane;
an elongate support member connected to the top end cap at a first end and connected to the bottom end cap at a second end.

17. The filtration unit of claim 16 comprising a plurality of elongate support members disposed around a circumference of the filter membrane.

18. The filtration unit of claim 16, wherein the elongate support member comprises a perforated sleeve surrounding the filter membrane and having a plurality of perforations formed therein.

19. The filtration unit of claim 17, wherein the elongate support member is connected to the top end cap and the bottom end cap having a gap between an inner surface of the elongate support member and a surface of the filter membrane.

20. The filtration unit of claim 16 further comprising an outer filter membrane disposed at least partially around the filter membrane.
